(19) United States
(12) Patent Application Publication
(10) Pub. No.: US 2019/0317701 A1
(43) Pub. Date: Oct. 17, 2019

(54) IMAGE FORMING APPARATUS, METHOD OF CONTROLLING IMAGE FORMING APPARATUS, AND PROGRAM

(71) Applicant: Konica Minolta Inc., Tokyo (JP)

(72) Inventor: Osamu SHIMOTOSO, Nishinomiya-shi (JP)

(21) Appl. No.: 16/382,693

(22) Filed: Apr. 12, 2019

(30) Foreign Application Priority Data
Apr. 16, 2018 (JP) 2018-078438

(51) Int. Cl. G06F 3/12; G06F 3/16; G06F 3/14; G03G 15/00

(52) U.S. Cl. CPC G06F 3/121; G03G 15/5016; G06F 3/14; G06F 3/167

(57) ABSTRACT

An image forming apparatus includes: a hardware processor that sequentially guides a worker to a plurality of work stages and determines completion of each of the plurality of work stages with a completion-determination method; at least one sensor capable of detecting a final state of at least one work stage of the plurality of work stages; and a voice inputter capable of receiving a voice input from the worker, wherein the plurality of work stages is classified into a first type of stage and a second type of stage in advance, and the hardware processor: determines, in a case where a current work stage in the plurality of work stages belongs to the first type of stage, completion of the current work stage; and determines, in a case where the current work stage belongs to the second type of stage, the completion of the current work stage.

### CROSS-REFERENCE TO RELATED APPLICATION

The present invention claims priority under 35 U.S.C. § 119 to Japanese patent Application No. 2018-078438, filed on Apr. 16, 2018, is incorporated herein by reference in its entirety.

### BACKGROUND

### Technological Field

The present invention relates to an image forming apparatus, such as a multi-functional peripheral (MFP), and a technology associated with the image forming apparatus.

### Description of the Related Art

For example, in a case where an image forming apparatus has occurrence of an abnormal event (e.g., a paper jam), a plurality of work stages according to work to be conducted by a worker at the image forming apparatus (e.g., elimination work of the paper jam) sequentially guides the worker. Then, the worker sequentially conducts each work stage in accordance with the guide of the image forming apparatus, and additionally performs, after completion of each work stage, a depression operation, for example, to a “completion” button (button for notifying the image forming apparatus of the completion of each work stage) displayed on an operation screen of the image forming apparatus. The image forming apparatus determines the effect that each work stage has been completed, on the basis of the depression operation of the worker.

Note that performing a depression operation to the “completion” button on the operation screen of the image forming apparatus after completion of each work stage, annoys the worker (extremely).

As a technique made in consideration of the point, there is a technique of determining completion of each work stage with a sensor (refer to JP 2007-230001 A). According to this technique, the completion of each work stage is automatically determined on the basis of a detected result of the sensor. Thus, a worker is not required to perform an operation (manual operation) on an operation screen of an image forming apparatus after the completion of each work stage, so that the work efficiency of the worker can improve (dramatically).

There is a technique of determining completion of each work stage on the basis of a voice input of the effect that each work stage has been conducted, from a worker (refer to JP 2003-215985 A). According to this technique, the worker is not required to perform an operation (e.g., a depression operation to a “completion” button) on an operation screen of an image forming apparatus after the completion of each work stage. Thus, the work efficiency of the worker can improve.

However, because the technique described in JP 2007-230001 A typically adopts only the sensor for determining the completion of each work stage and the technique described in JP 2003-215985 A typically adopts only the voice input for determining the completion of each work stage, each technique has room for further improvement of the work efficiency of the worker.

For example, according to the technique described in JP 2007-230001 A, completion of all the work stages is not necessarily detected with the sensor. In a case where a work stage is present of which completion is not to be detected with the sensor, even when the worker conducts the work stage, the effect that the work stage has been completed is not automatically determined. As a result, the worker is required to perform an operation (e.g., a depression operation to a “completion” button) (namely, an annoying operation) on the operation screen of the image forming apparatus after the completion of the work stage.

According to the technique described in JP 2003-215985 A, the worker is not required to perform a depression operation to, for example, a “completion” button on the operation screen of the image forming apparatus after the completion of each work stage. However, every time, the worker needs to perform voice input of the effect that each work stage has been conducted (effect that each work stage has been completed) (although simpler than an operation input on the operation screen).

### SUMMARY

Thus, an object of the present invention is to provide a technique enabling further improvement of the work efficiency of a worker.

To achieve the abovementioned object, according to an aspect of the present invention, an image forming apparatus reflecting one aspect of the present invention comprises: a hardware processor that sequentially guides a worker to a plurality of work stages according to work to be conducted by the worker at the image forming apparatus and determines completion of each of the plurality of work stages with a completion-determination method corresponding to a type of the work stage; at least one sensor capable of detecting a final state of at least one work stage of the plurality of work stages; and a voice inputter capable of receiving a voice input from the worker, wherein the plurality of work stages is classified into a first type of stage and a second type of stage in advance, and the hardware processor: determines, in a case where a current work stage in the plurality of work stages belongs to the first type of stage, completion of the current work stage, based on a detected result of a specific sensor corresponding to the current work stage in the at least one sensor; and determines, in a case where the current work stage belongs to the second type of stage, the completion of the current work stage, based on the voice input of an effect that the current work stage has been conducted.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an external view of an image forming apparatus (MFP);

FIG. 2 is a functional block diagram of the MFP;

FIG. 3 illustrates an outline of output control of work guidance information;

FIG. 4 is a flowchart of the operation of the MFP (guide operation of work stages);

FIG. 5 illustrates first-stage guidance information subjected to display output;

FIG. 6 illustrates the first-stage guidance information being subjected to voice output;

FIG. 7 illustrates second-stage guidance information subjected to display output;

FIG. 8 illustrates the second-stage guidance information being subjected to voice output;

FIG. 9 illustrates third-stage guidance information subjected to display output;

FIG. 10 illustrates the third-stage guidance information being subjected to voice output;

FIG. 11 is a flowchart of the operation of an MFP according to a second embodiment (guide operation of work stages);

FIG. 12 illustrates subroutine processing in display processing of detailed guidance information;

FIG. 13 illustrates subroutine processing in display processing of recovery guidance information;

FIG. 14 illustrates the recovery guidance information;

FIG. 15 illustrates first-stage guidance information according to a modification;

FIG. 16 illustrates second-stage guidance information according to the modification;

FIG. 17 illustrates third-stage guidance information according to the modification; and

FIG. 18 illustrates fourth-stage guidance information according to the modification.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

<1-1. Configuration Overview>

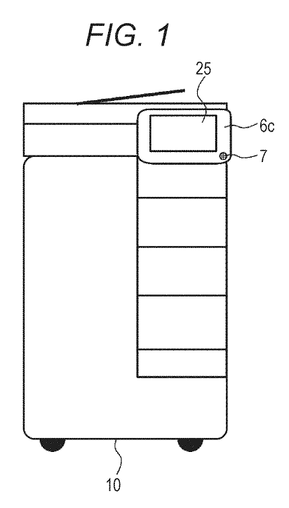

FIG. 1 is an external view of a multi-functional peripheral (MFP) 10.

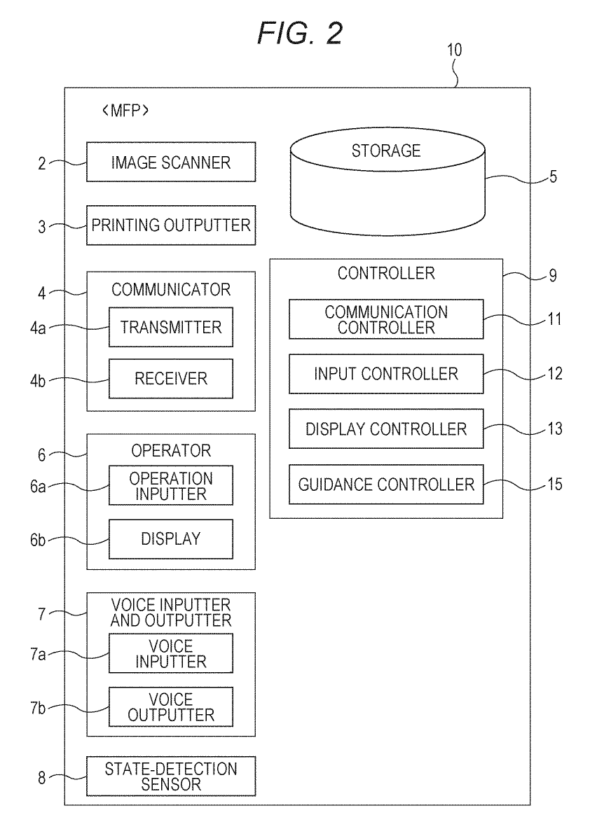

FIG. 2 is a functional block diagram of the MFP 10.

The MFP 10 is an apparatus having, for example, a scan function, a copy function, a facsimile function, and a box-storage function (also, referred to as a multi-functional printer). Specifically, as illustrated in the functional block diagram of FIG. 2, the MFP 10 including an image scanner 2, a printing outputter 3, a communicator 4, a storage 5, an operator 6, a voice inputtter and outputter 7, a state-detection sensor 8, and a controller 9, operates each unit on a multiple basis to achieve the various functions. Note that the MFP 10 is also referred to as an image forming apparatus or an image processing apparatus.

The image scanner 2 is a processor that optically reads (namely, scans) an original mounted on a predetermined position in the MFP 10, to generate image data of the original (also, referred to as an original image or a scanned image).

The printing outputter 3 is an outputter that performs printing output of an image on various media, such as paper, on the basis of data regarding a printing target (printing-target data).

The communicator 4 is a processor capable of performing facsimile communication through, for example, a public line. Furthermore, the communicator 4 is capable of performing network communication through a network. For example, various protocols, such as Transmission Control Protocol/Internet Protocol (TCP/IP), are used in the network communication. Use of the network communication enables the MFP 10 to perform transmission and reception of various types of data between a desired destination and the MFP 10. The communicator 4 includes a transmitter 4a that transmits various types of data and a receiver 4b that receives various types of data.

The storage 5 includes storage devices, such as a hard disk drive (HDD) and a semiconductor memory.

The operator 6 includes an operation inputter 6a that receives an operation input to the MFP 10 (an operation input to, for example, an operation panel 6c) and a display (display outputter) 6b that performs display output of various types of information (e.g., work guidance information 300 (to be described later)).

The MFP 10 is provided with the operation panel 6c that is substantially tabular in shape (refer to FIG. 1). The operation panel 6c includes a touch panel 25 on the front side thereof (refer to FIG. 1). The touch panel 25 functions as part of the operation inputter 6a and additionally functions as part of the display 6b. The touch panel 25 includes a liquid crystal display panel in which, for example, various sensors are embedded. The touch panel 25 is capable of displaying various types of information and additionally is capable of receiving various operation inputs from a handler.

The voice inputter and outputter 7 (refer to FIG. 1) includes a voice inputter 7a (e.g., a microphone) and a voice outputter 7b (e.g., a speaker). The voice inputter 7a is capable of recognizing a voice emitted by a worker (e.g., a user or a serviceman) and receiving a voice input from the worker. The voice outputter 7b is capable of performing vice output of the work guidance information 300 (to be described later).

The MFP 10 is provided with a plurality of state-detection sensors 8. The state-detection sensors 8 are each capable of directly detecting the final state of at least one work stage of a plurality of work stages according to work to be conducted by the worker at the MFP 10.

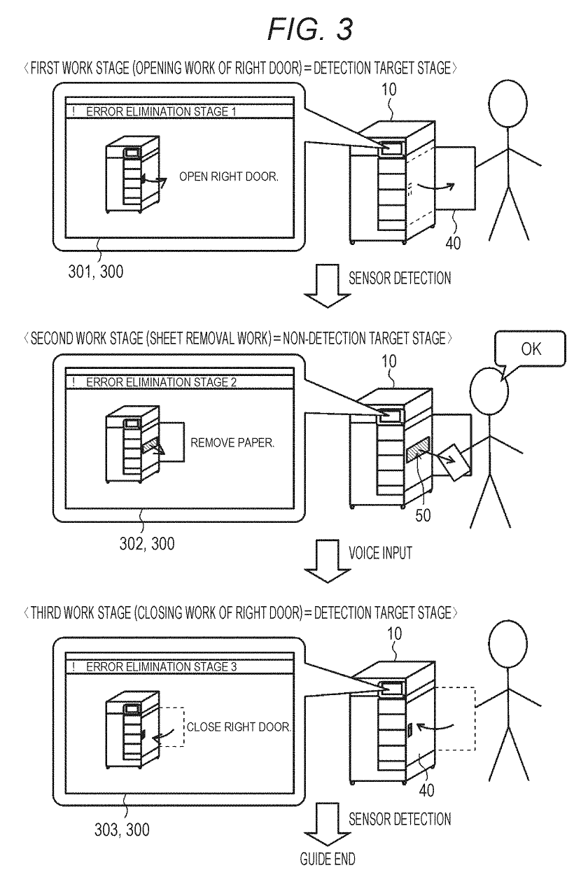

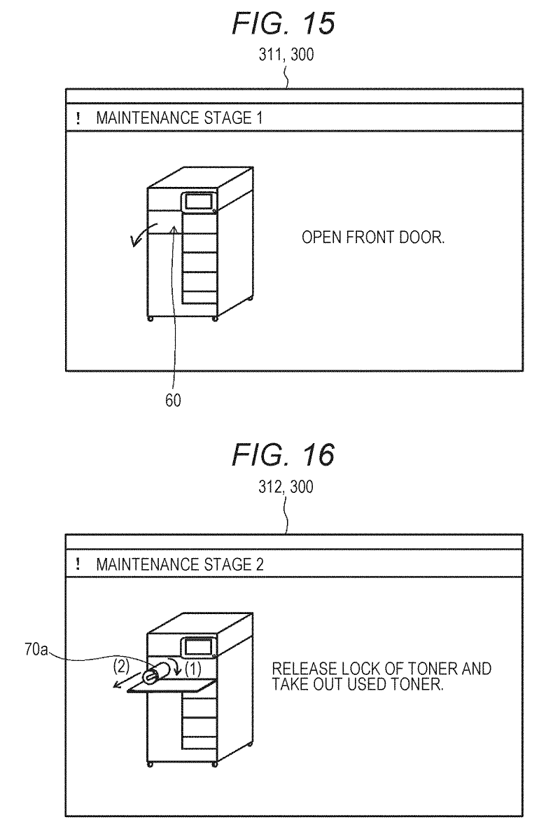

For example, a member openable and closable in the MFP 10 (openable and closable member) is provided with, as a state-detection sensor 8, a sensor capable of directly detecting the open/closed state of the openable and closable member (the open state and the closed state) (also, referred to as an open/closed detection sensor). The open/closed detection sensor is used as a sensor capable of directly detecting the final state of opening work of the openable and closable member that is a detection target (the open state of the openable and closable member) (state-detection sensor 8) and additionally is used as a sensor capable of directly detecting the final state of closing work of the openable and closable member (the closed state of the openable and closable member) (state-detection sensor 8). Note that, as the openable and closable member, a door provided at the right face of the MFP 10 (right door 40 (FIG. 3)), a door provided at the front face of the MFP 10 (front door 60 (FIG. 15)), and a paper-feeding tray are exemplified.

The open/closed detection sensor is provided per detection target member (detection target). For example, the right door 40 (FIG. 3) is provided with, as a state-detection sensor 8, an open/closed detection sensor that detects the open/closed state of the right door 40 (open/closed detection sensor for the right door 40). The front door 60 (FIG. 15) is provided with, as a state-detection sensor 8, an open/closed detection sensor that detects the open/closed state of the front door 60 (open/closed detection sensor for the front door 60).

As each open/closed detection sensor, here, a photo sensor is exemplified.

For example, in a case where an openable and closable member (e.g., the right door 40) is in the closed state, a light-receiving element (light-receiving element provided at the right door 40) receives light emitted from a light-emitting element (light-emitting element provided at the body of the MFP 10) in the photosensor (photosensor for the right door 40), resulting in detection of the closed state of the right door 40. After that, transition of the right door 40 from the closed state to the open state (namely, the right door 40 opens) causes the light-receiving element not to receive the light emitted from the light-emitting element in the photosensor for the right door 40, resulting in detection of the change of the right door 40 from the closed state to the open state. Furthermore, after that, re-transition of the right door 40 from the open state to the closed state (namely, the right door 40 closes) causes the light-receiving element to re-receive the light emitted from the light-emitting element in the photosensor for the right door 40, resulting in detection of the change of the right door 40 from the open state to the closed state.

Note that, here, each open/closed detection sensor includes, but is not limited to, the photosensor. Each open/closed detection sensor may include a different type of sensor (e.g., a gyroscope sensor or an image sensor). For example, a gyroscope sensor may be provided, as the open/closed detection sensor for the right door 40, at the right door 40. The open/closed state of the right door 40 (open/closed angle) may be detected on the basis of an output value of the gyroscope sensor when the right door 40 opens or closes. An image sensor (e.g., a camera) may be provided, as the open/closed detection sensor for the right door 40, for example, on the ceiling of the upper portion of the MFP 10. The open/closed state of the right door 40 may be detected on the basis of a shoot image of the image sensor when the right door 40 opens or closes.

The controller 9 is a control device that is built in the MFP 10 and controls the MFP 10 in a unificatory manner. The controller 9 includes a computer system including, for example, a central processing unit (CPU) (also, referred to as a microprocessor or a computer processor) and various semiconductor memories (a RAM and a ROM). The CPU of controller 9 executes a predetermined software program (hereinafter, also simply referred to as a program) stored in the ROM (e.g., EEPROM (registered trademark)), to achieve various processors. Note that the program (in detail, a program module group) may be recorded on a portable recoding medium, such as a USB memory. The program read from the recording medium may be installed on the MFP 10. Alternatively, the program downloaded through, for example, a network may be installed on the MFP 10.

Specifically, as illustrated in FIG. 2, for example, due to the execution of the program, the controller 9 achieves the various processors including a communication controller 11, an input controller 12, a display controller 13, and a guidance controller 15.

The communication controller 11 is a processor that controls communication operation to a different apparatus, being cooperative with, for example, the communicator 4.

The input controller 12 is a controller that controls input operation to the operation inputter 6a (e.g., the touch panel 25).

The display controller 13 is a processor that controls display operation at the display 6b (e.g., the touch panel 25).

The guidance controller (also, referred to as a guide controller) 15 is a processor that performs control (guide control) of sequentially guiding the worker to the plurality of work stages (a plurality of work steps) according to the work to be conducted by the worker (a series of work) at the MFP 10. Specifically, the guidance controller 15 outputs the work guidance information 300 (to be described next) to sequentially guide the worker to the plurality of work stages. The work guidance information 300 is information for guiding the worker to the plurality of work stages. The work guidance information 300 is also referred to as work guide information. The guidance controller 15 performs, for example, determination operation of determining completion of each work stage with a completion-determination method corresponding to the type of each work stage.

Note that, here, the execution of the software program by the CPU of the controller 9 mainly allows performance of the various types of operation, but the present embodiment is not limited to this. The various types of operation may be performed with, for example, dedicated hardware provided at the MFP 10 (in detail, inside or outside the controller 9). For example, all or part of the communication controller 11, the input controller 12, the display controller 13, and the guidance controller 15 (FIG. 2) may be achieved with one piece or a plurality of pieces of dedicated hardware.

<1-2. Operation>

FIG. 3 illustrates an outline of output control of the work guidance information 300 (guide control of a plurality of work stages). Here, it is assumed that an abnormal event has occurred in the MFP 10 (in detail, a paper jam on a sheet conveyance path in the MFP 10).

Here, a series of work to be conducted by the worker in order to eliminate the paper jam occurring in the MFP 10 (elimination work of the paper jam), includes three pieces of elemental work (work stages): work of opening the right door 40 (FIG. 3) (opening work), work of removing a sheet from a paper-jam portion 50 (FIG. 3) (sheet removal work), and work of closing the right door 40 (closing work).

The MFP 10 has the three work stages previously classified by, for example, a designer of the program into two types of stages: a detection target stage and a non-detection target stage. The detection target stage is a work stage of which completion is detected with a state-detection sensor 8 (in detail, a sensor corresponding to the current work stage, in the plurality of state-detection sensors 8). The non-detection target stage is a work stage of which completion is not detected with a state-detection sensor 8.

Specifically, on the basis of whether each work stage is a work stage of which completion can be detected with a state-detection sensor 8, the three work stages are each classified into the detection target stage or the non-detection target stage. More specifically, from the three work stages, a work stage of which completion can be detected with the sensor corresponding to the current work stage (also, referred to as a detectable stage) is classified into the detection target stage. Meanwhile, from the three work stages, a work stage of which completion cannot be detected with a state-detection sensor 8 (also, referred to as an undetectable stage) is classified into the non-detection target stage. Note that, the present embodiment is not limited to this. On the basis of a different criterion, the three work stages may be classified into the detection target stage and the non-detection target stage.

Here, as to be described later, from the plurality of work stages according to the elimination work of the paper jam (three work stages), the opening work of the right door 40 of the MFP 10 (work of opening the right door 40) and the closing work of the right door 40 of the MFP 10 (work of closing the right door 40) are classified into the detection target stage, and the sheet removal work is classified into the non-detection target stage.

The MFP 10 determines completion of the detection target stage (here, the opening work or the closing work of the right door 40) from the three work stages, on the basis of a detected result of the sensor (refer to FIG. 3). Meanwhile, the MFP 10 determines completion of the non-detection target stage (here, the sheet removal work) from the three work stages, on the basis of a voice input from the worker (refer to FIG. 3).

In this manner, on the basis of whether each work stage belongs to the type of either the detection target stage or the non-detection target stage, a completion-determination method for each work stage is selected. In other words, in order to determine the completion of each work stage (each piece of elemental work), the sensor or the voice input is used, on the basis of whether each work stage belongs to either the detection target stage or the non-detection target stage.

The details of this operation will be described below.

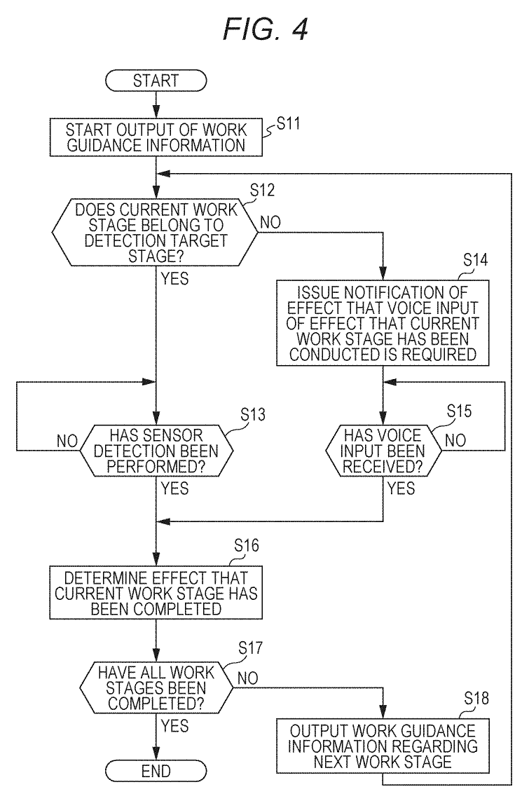

FIG. 4 is a flowchart of the operation of the MFP 10 (particularly, guide operation of work stages). The flowchart of FIG. 4 starts in response to the occurrence of the paper jam (abnormal event) in the MFP 10.

First, at step S11, the MFP 10 starts a guide of the plurality of work stages according to the work to be conducted by the worker at the MFP 10 (work guide).

Specifically, the MFP 10 starts output of the work guidance information 300 (information for guiding the worker to the plurality of work stages). Here, information for guiding the worker to elimination stages for the abnormal event (paper jam) occurring in the MFP 10 (also, referred to as elimination-stage information), is output as the work guidance information 300. Here, the work guidance information 300 is subjected to display output (image output) through the touch panel 25, and the work guidance information 300 is subjected to voice output through the voice outputter 7b.

More specifically, from a plurality of pieces of work guidance information 301 to 303 (300) regarding the plurality of work stages according to the elimination work of the paper jam (refer to FIG. 3), the MFP 10 starts output (display output and voice output) of the work guidance information 301 regarding the first work stage (also, referred to as first-stage guidance information). Here, the first work stage includes the work of opening the door provided at the right face of the MFP 10 (right door 40 (refer to FIG. 3)) (opening work of the right door 40).

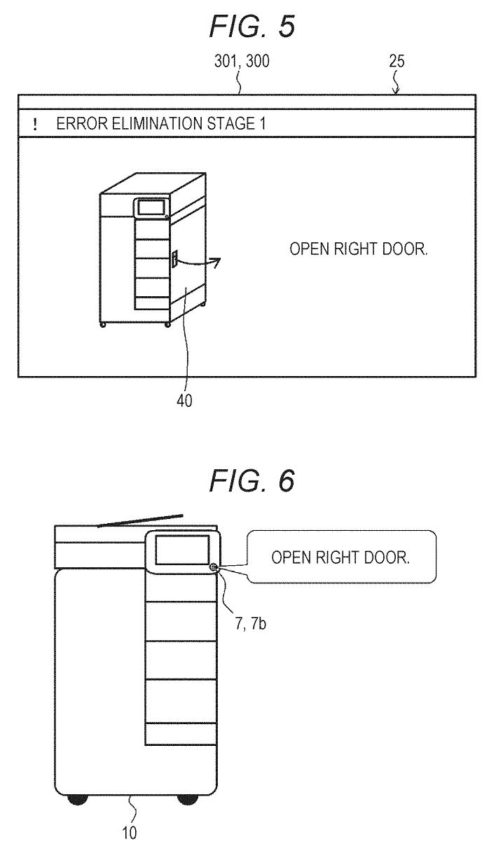

FIG. 5 illustrates the first-stage guidance information 301 subjected to display output. As illustrated in FIG. 5, the MFP 10 performs display output of both of a graphic guidance expressing the first work stage (opening work of the right door 40) in illustration (graphic imitating the MFP) and a text guidance expressing the first work stage in text (“Open the right door”), onto the touch panel 25. Note that the present embodiment is not limited to this, and thus either the graphic guidance or the text guidance may be subjected to display output.

FIG. 6 illustrates the first-stage guidance information 301 being subjected to voice output. As illustrated in FIG. 6, the MFP 10 performs voice output of a voice guidance for describing the first work stage (opening work of the right door 40) (“Open the right door”).

This arrangement allows the worker to verify the work contents of the first work stage (opening work of the right door 40).

Then, the processing proceeds from step S11 to step S12.

At step S12, the MFP 10 determines whether the current work stage (here, the first work stage) (currently in guiding) belongs to either the detection target stage or the non-detection target stage. Then, the MFP 10 selects (determines) a completion-determination method for the current work stage, on the basis of whether the current work stage belongs to either the detection target stage or the non-detection target stage.

Here, the MFP 10 has in advance a registration of whether each work stage belongs to either the detection target stage or the non-detection target stage.

For example, the right door 40 (peripheral portion of the right door 40) is provided with, as a state-detection sensor 8, the open/closed detection sensor capable of detecting the final state of the opening work of the right door 40 (state where the right door 40 is open). Here, the effect that the opening work of the right door 40 belongs to the detection target stage (detection target work), is registered in advance. On the basis of the registered content, the effect that the first work stage (opening work of the right door 40) belongs to the detection target stage (classified in the detection target stage), is determined at step S12. Then, the processing proceeds from step S12 to step S13.

At step S13, the MFP 10 is in wait for a detected result of the state-detection sensor 8 (here, the open/closed detection sensor corresponding to the opening work of the right door 40, in the plurality of state-detection sensors 8). In other words, it is determined whether the detection target stage (opening work of the right door 40) has been completed.

Specifically, the MFP 10 determines whether the work target in the current work stage (detection target stage) has varied to the final state of the current work stage (state after completion of the current work stage). Here, it is determined whether the right door 40 (work target in the first work stage) has varied from the closed state to the open state (final state of the opening work).

For example, when the worker conducts the opening work of the right door 40 in accordance with the first-stage guidance information 301 (FIG. 5 and FIG. 6) (refer to FIG. 3), the open/closed detection sensor for the right door 40 (open/closed detection sensor corresponding to the opening work of the right door 40) detects the effect that the right door 40 is in the open state (final state). Acquisition of a detected result of the effect that the right door 40 is in the open state, causes determination of the effect that the right door 40 has varied (attained) from the closed state to the open state (final state of the first work stage), at step S13.

Then, the processing proceeds from step S13 to step S16, and the MFP 10 determines the effect that the current work stage (here, the first work stage) has been completed (step S16).

In this manner, in a case where the current work stage (here, the opening work of the right door 40) belongs to the detection target stage, the completion of the current work stage is determined on the basis of the detected result of the state-detection sensor 8 (in detail, the open/closed detection sensor for the right door 40, in the plurality of state-detection sensors 8).

Then, the processing proceeds from step S16 to step S17, and then it is determined whether all the work stages have been completed. Here, the effect that uncompleted work stages (remaining work stages (second and third work stages) except the first work stage in the three work stages regarding the elimination work of the paper jam) are left is determined at step S17. Then, the processing proceeds from step S17 to step S18.

At step S18, the MFP 10 finishes the display output of the current work guidance information 300 (first-stage guidance information 301) and additionally starts a guide of the next work stage (remaining work stage (here, the second work stage)).

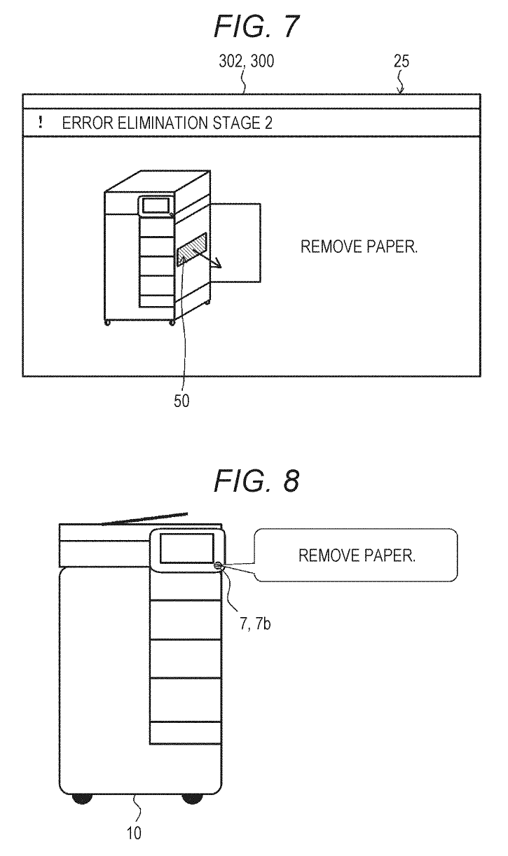

Specifically, from the plurality of pieces of work guidance information 301 to 303 (300) regarding the elimination work of the paper jam, the MFP 10 starts output (display output and voice output) of the work guidance information 302 regarding the second work stage (also, referred to as second-stage guidance information). Here, the second work stage includes the work of removing the sheet from the paper-jam portion 50 on the sheet conveyance path in the MFP 10 (sheet removal work) (refer to FIG. 7).

FIG. 7 illustrates the second-stage guidance information 302 subjected to display output. As illustrated in FIG. 7, the MFP 10 performs display output of a graphic guidance expressing the second work stage (sheet removal work) in illustration (graphic imitating the MFP) and a text guidance expressing the second work stage in text (“Remove the paper”).

FIG. 8 illustrates the second-stage guidance information 302 being subjected to voice output. As illustrated in FIG. 8, the MFP 10 performs voice output of a voice guidance for describing the second work stage (“Remove the paper”).

Then, for the second work stage, similarly, it is determined at step S12 whether the second work stage (sheet removal work) belongs to either the detection target stage or the non-detection target stage.

Here, a sensor itself capable of detecting a paper-jam state is provided on the sheet conveyance path in the MFP 10. However, along with the opening work of the right door 40, the sensor for the paper-jam portion 50 on the sheet conveyance path (namely, a portion with which fingers of the worker can come in contact) transitions to a non-conductive state. As a result, during the elimination work of the paper jam, the sensor cannot detect the final state of the sheet removal work (state where the sheet has been removed from the paper-jam portion 50) (does not perform detection operation). In consideration of the point, here, the effect that the sheet removal work belongs to the non-detection target stage (non-detection target work), is registered in advance. On the basis of the registered content, the effect that the second work stage (sheet removal work) belongs to the non-detection target stage (classified in the non-detection target stage), is determined at step S12. Then, the processing proceeds from step S12 to step S14.

At step S14, the MFP 10 notifies the worker of the effect that voice input is required for the effect that the current work stage has been conducted. Specifically, a voice message, such as “Vocalize “OK” after completion of the work”, is output.

Then, the processing proceeds from step S14 to step S15. The MFP 10 is in wait for a voice input from the worker (voice input of the effect that the current work stage has been conducted). In other words, it is determined whether the non-detection target stage (sheet removal work) has been completed. Specifically, the MFP 10 determines whether the voice input of the effect that the non-detection target stage (here, the second work stage) has been conducted has been received (voice input from the worker).

For example, when the worker emits a voice of the effect that the sheet removal work has been conducted (“OK”) (refer to FIG. 3) after the worker conducts the sheet removal work in accordance with the second-stage guidance information 302, the voice inputter 7a of the MFP 10 recognizes the voice and additionally receives the voice input from the worker (voice input of the effect that the current work stage has been conducted).

After the reception of the voice input from the worker, the processing proceeds from step S15 to step S16. The MFP 10 determines the effect that the second work stage (sheet removal work) has been completed.

In this manner, in a case where the current work stage (here, the sheet removal work) belongs to the non-detection target stage, the completion of the current work stage is determined on the basis of the voice input of the effect that the current work stage has been conducted, from the worker.

Then, the effect that an uncompleted work stage (in detail, the third work stage) is left is determined at step S17. The processing proceeds from step S17 to step S18.

After that, at step S18, the MFP 10 finishes the display output of the second-stage guidance information 302, and additionally starts a guide of the next work stage (third work stage).

Specifically, from the plurality of pieces of work guidance information 301 to 303 (300) regarding the elimination work of the paper jam, the MFP 10 starts output (display output and voice output) of the work guidance information 303 regarding the third (last) work stage (also, referred to as third-stage guidance information). Here, the third work stage includes the work of closing the right door 40 (closing work of the right door 40) (refer to FIG. 3).

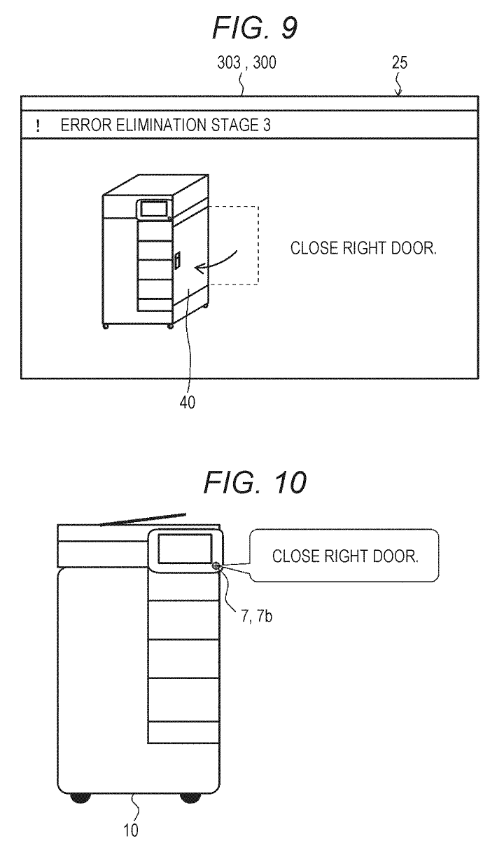

FIG. 9 illustrates the third-stage guidance information 303 subjected to display output. As illustrated in FIG. 9, the MFP 10 performs display output of a graphic guidance expressing the third work stage (closing work of the right door 40) in illustration (graphic imitating the MFP) and a text guidance expressing the third work stage in text (“Close the right door”).

FIG. 10 illustrates the third-stage guidance information 303 being subjected to voice output. As illustrated in FIG. 10, the MFP 10 performs voice output of a voice guidance for describing the third work stage (“Close the right door”).

Then, for the third work stage, similarly, it is determined at step S12 whether the third work stage (closing work of the right door 40) belongs to either the detection target stage or the non-detection target stage.

Here, similarly to the opening work of the right door 40, the effect that the closing work of the right door 40 belongs to the detection target stage, is registered in advance. The effect that the third work stage (closing work of the right door 40) belongs to the detection target stage, is determined at step S12. Then, the processing proceeds from step S12 to step S13.

After that, when the worker conducts the closing work of the right door 40, the state-detection sensor 8 of the MFP 10 (here, the open/closed detection sensor corresponding to the opening work of the right door 40, in the plurality of state-detection sensors 8 (open/closed detection sensor for the right door 40)) detects the effect that the right door 40 is in the closed stage (final state of the closing work). Acquisition of a detected result of the effect that the right door 40 is in the closed state, causes determination of the effect that the right door 40 has varied (attained) from the open state to the closed state (final state of the closing work), at step S13.

Then, the processing proceeds from step S13 to step S16. The effect that the third work stage has been completed, is determined. After that, the effect that all the work stages according to the elimination work of the paper jam have been completed, is determined at step S17. The processing of FIG. 4 finishes.

As described above, according to the first embodiment, in a case where the current work stage (e.g., the opening work of the right door 40) belongs to the detection target stage, in the plurality of work stages of the elimination work of the paper jam, the completion of the current work stage is automatically determined on the basis of the detected result of the sensor corresponding to the current work stage (here, the open/closed detection sensor for the right door 40) (refer to FIG. 3). Meanwhile, in a case where the current work stage (e.g., the sheet removal work) belongs to the non-detection target stage, the completion of the current work stage is determined on the basis of the voice input from the worker (voice input of the effect that the sheet removal work has been conducted) (refer to FIG. 3). Thus, after the completion of the detection target stage, the worker is not required to perform an operation input for notification of the effect that the work has been conducted (e.g., a button-depression operation on an operation screen of the MFP 10 and an voice input). After the completion of the non-detection target stage, the worker is required at least to perform an operation input (voice input) easier than a button-depression operation on the operation screen of the MFP 10. Therefore, the work efficiency of the worker can more improve.

Furthermore, according to the first embodiment, the work guidance information 300 (information for guiding the worker to the plurality of work stages according to the work to be conducted by the worker) is subjected to voice output (refer to FIG. 6, FIG. 8, and FIG. 10). Thus, the worker can recognize each work stage without viewing the work guidance information 300 displayed on the operation screen of the MFP 10. Therefore, the work efficiency of the worker can further improve.

Note that, according to the first embodiment, both of the display output (refer to FIG. 5, FIG. 7, and FIG. 9) and the voice output (refer to FIG. 6, FIG. 8, and FIG. 10) are adopted as a method of outputting the work guidance information 300 (301 to 303), but the present embodiment is not limited to this. Only one of the display output and the voice output (only the display output or only the voice output) may be adopted as a method of outputting the work guidance information 300.

### 2. Second Embodiment

A second embodiment is a modification of the first embodiment. The difference between the second embodiment and the first embodiment, will be mainly described below.

According to the second embodiment, in addition to the operation according to the first embodiment, in a case where the effect that a worker is confused about the current work stage (work stage in currently guiding) is determined, information for a more detailed guide of the current work stage (also, referred to as detailed guidance information) is subjected to display output on a touch panel 25.

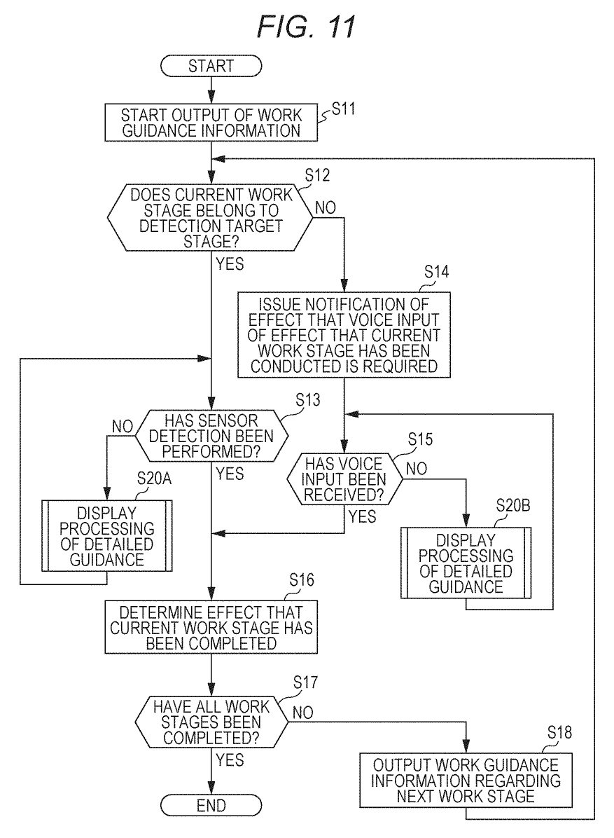

FIG. 11 is a flowchart of the operation of an MFP 10 according to the second embodiment (particularly, guide operation of work stages). In FIG. 11, the processing at step S20A is performed in wait for a detected result of a state-detection sensor 8 (step S13), and additionally the processing at step S20B is performed in wait for a voice input from the worker (step S14). Note that the processing contents at steps S11 to S18 of FIG. 11 are similar to the processing contents at steps S11 to S18 of FIG. 4.

At step S20A and step S20B, display processing of the detailed guidance information is performed.

The operation at step S20A will be described below. After the effect that the current work stage (e.g., the first work stage (opening work of a right door 40)) belongs to a detection target stage, is determined at step S12, the operation at step S20A is performed in wait for the detected result of the state-detection sensor 8 (here, an open/closed detection sensor for the right door 40) (step S13).

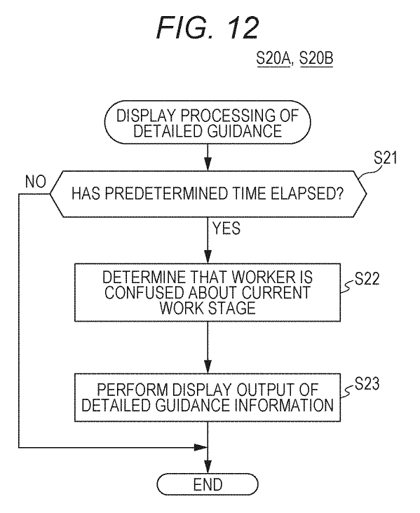

FIG. 12 illustrates subroutine processing at step S20A (display processing of the detailed guidance information).

First, at step S21 (FIG. 12), the MFP 10 determines whether a predetermined time (e.g., 30 seconds) has elapsed after output (here, display output (FIG. 5) and voice output (FIG. 6)) of current work guidance information 300 (here, first-stage guidance information 301) starts.

In a case where the predetermined time has not elapsed after the output of the first-stage guidance information 301 starts, the processing of FIG. 12 (step S20A) finishes. The processing goes back to step S13 (FIG. 11). Then, the processing at steps S13 and S21 repeats in wait for the detected result of the open/closed detection sensor for the right door 40.

After that, without acquisition of the detected result of the open/closed detection sensor for the right door 40, when the predetermined time elapses after the output (the display output and the voice output) of the current work guidance information 301 starts, the processing proceeds from step S21 to step S22.

At step S22, the MFP 10 determines the effect that the worker is confused (hesitating) about the current work stage (here, the first work stage (opening work of the right door 40) in the plurality of work stages). In detail, in a case where the final state of the first work stage (opening work of the right door 40) is not detected by the sensor regardless of the elapse of the predetermined time (here, 30 seconds) after the output of the first-stage guidance information 301 starts, the effect that the worker is confused about the first work stage is determined (estimated). Then, the processing proceeds from step S22 to step S23.

At step S23, the MFP 10 performs display output of the detailed guidance information (also, referred to as detailed guide information) that is the information for a more detailed guide of the current work stage (first work stage), onto the touch panel 25 (not illustrated). As the detailed guidance information, for example, an animation guidance is exemplified for a guide of the first work stage with an animation indicating that the work target (right door 40) in the first work stage varies gradually from the state before the work (closed state) to the final state (open state).

After that, when the worker who has verified the detailed guidance information conducts the first work stage, the processing proceeds from step S13 (FIG. 11) to step S16. The processing at and after step S16 is similar to that according to the first embodiment (FIG. 4).

Note that, similarly to step S20A, the subroutine processing of FIG. 12 is performed at step S20B (FIG. 11).

After the effect that the current work stage (e.g., the second work stage (sheet removal work)) belongs to a non-detection target stage, is determined at step S12, the operation at step S20B is performed in wait for the voice input from the worker (step S15).

Specifically, at step S21 (FIG. 12), it is determined whether a predetermined time (e.g., 30 seconds) has elapsed after output (display output (FIG. 7) and voice output (FIG. 8)) of the current work guidance information 300 (here, second-stage guidance information 302) starts.

Without reception of the voice input from the worker, when the predetermined time elapses after the output of the current work guidance information 302 starts, the processing proceeds from step S21 to step S22. The effect that the worker is confused about the second work stage (non-detection target stage) in the plurality of work stages, is determined.

Then, the processing proceeds from step S22 to step S23. The detailed guidance information is subjected to display output on the touch panel 25.

Then, when the voice input from the worker (“OK”) is received after the worker who has verified the detailed guidance information conducts the second work stage, the processing proceeds from step S15 (FIG. 11) to step S16. The processing at and after step S16 is similar to that according to the first embodiment (FIG. 4).

As described above, according to the second embodiment, in a case where the effect that the worker is confused about the current work stage is determined, the detailed guidance information for a more detailed guide of the current work stage is automatically subjected to display output. Thus, the worker is not required to perform, on an operation screen of the MFP 10, a button operation (e.g., a depression operation to a “detail” button) for performing display output of the detailed guidance information. Therefore, the display output of the detailed guidance information can be performed efficiently.

Note that, here, in a case where the detected result of the state-detection sensor 8 is not acquired (or the voice input is not received) by the elapse of the predetermined time after the output of the current work guidance information 300 starts, the effect that the worker is confused about the current work stage is determined (steps S21 and S22). However, the present embodiment is not limited to this.

For example, in a case where a voice input of the effect that the worker is confused about the current work stage, is received, the effect that the worker is confused about the current work stage may be determined. Specifically, in a case where a voice input, such as “I am baffled”, is received after the current work guidance information 300 is output, the effect that the worker is confused about the current work stage may be determined.

According to the second embodiment, in a case where the effect that the worker is confused about the current work stage is determined, the detailed guidance information is subjected to display output (not illustrated). However, the present embodiment is not limited to this. For example, in a case where the effect that the worker is confused about the current work stage is determined, the current work guidance information 300 may be subjected to voice output again, instead of display output of the detailed guidance information. For example, in a case where the effect that the worker is confused about the first work stage in the plurality of work stages is determined, the first-stage guidance information 301 may be subjected to voice output again (refer to FIG. 6).

Furthermore, in a case where the effect that the worker is confused about the current work stage is determined, the current work guidance information 300 may be subjected to voice output again in addition to display output of the detailed guidance information.

### 3. Third Embodiment

A third embodiment is a modification of the first embodiment. The difference between the third embodiment and the first embodiment, will be mainly described below.

According to the third embodiment, in addition to the operation according to the first embodiment, in a case where the effect that different work from the current work stage has been conducted at the current work stage is determined, information for recovering the state before the conduct of the different work (original state) (also, referred to as recovery guidance information 500) is output (refer to FIG. 14).

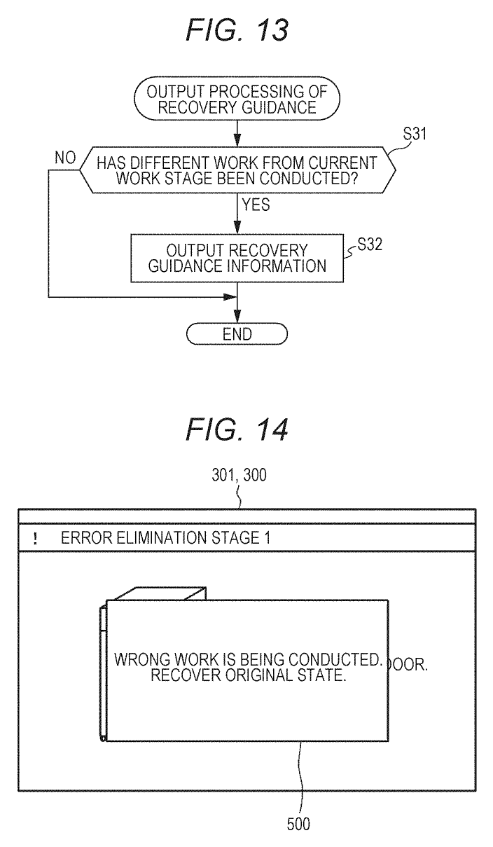

FIG. 13 illustrates subroutine processing in display processing of the recovery guidance information 500. Output processing of the recovery guidance information 500 is performed in wait for a detected result of a state-detection sensor 8 (or in wait for a voice input), similarly to the display processing of the detailed guidance information according to the second embodiment (steps S20A and S20B (FIG. 11)).

First, at step S31 (FIG. 13), an MFP 10 determines whether different work from the current work stage (namely, wrong work) has been conducted at the current work stage (e.g., the first work stage (opening work of a right door 40)).

Specifically, in a case where a state-detection sensor 8 detects, at the first work stage, a variation in the state of a different object from the work target in the first work stage (in detail, a sensor capable of detecting a variation in the state of the different object, in a plurality of state-detection sensors 8), the MFP 10 determines the effect that the wrong work has been conducted. For example, in a case where a different door (e.g., a front door 60), which is open, from the right door 40 (work target in the first work stage), is detected by the state-detection sensor 8 (open/closed detection sensor for the front door 60) at the first work stage, the effect that the wrong work has been conducted is determined.

Alternatively, in a case where a voice input of the effect that the wrong work has been conducted (e.g., a voice input of the content of “I made a mistake”) is received at the first work stage, the MFP 10 determines the effect that the wrong work has been conducted.

After the determination of the effect that the wrong work has been conducted, the processing proceeds from step S31 to step S32. The MFP 10 performs output (display output and voice output) of the information for recovering the state before the conduct of the wrong work (recovery guidance information 500). Specifically, the MFP 10 performs display output (FIG. 14) and voice output of a message of the effect that the state before (just before) the conduct of the wrong work (original state) should be recovered, as the recovery guidance information 500. FIG. 14 illustrates the recovery guidance information 500 subjected to the display output.

Then, after determination of the effect that the state before the conduct of the wrong work has recovered, the MFP 10 outputs work guidance information 300 regarding the current work stage (here, first-stage guidance information 301) again. Specifically, in a case where the sensor (open/closed detection sensor for the front door 60) detects that the wrongly opened front door 60 (different door from the right door 40) is closed, or in a case where a voice input of the effect of recovery of the original state (e.g., “I have recovered the original state”) is received, the effect that the state before the conduct of the wrong work (original state) has been recovered is determined. Then, the work guidance information 300 regarding the current work stage is output again.

As described above, according to the third embodiment, the determination of the effect that the wrong work has been conducted at the current work stage, causes automatic output of the recovery guidance information 500 (refer to FIG. 14).

Particularly, when the state-detection sensor 8 (here, the open/closed detection sensor for the front door 60) detects a variation in the state of the different object (e.g., the front door 60) from the work target (e.g., the right door 40) in the current work stage, the effect that the wrong work has been conducted is determined and additionally the recovery guidance information 500 is automatically output. Thus, even in a case of opening the front door 60 wrongly at the first work stage (opening work of the right door 40) although the right door 40 should be opened rightly, the worker can recognize the conduct of the wrong work, early. As a result, the worker recovers the original state (state just before the front door 60 opens), early.

Therefore, in a case where the worker conducts the different work (wrong work) from the current work stage, the state before the conduct of the wrong work (original state) can be recovered early. Furthermore, a reduction can be inhibited in the work efficiency of the entire elimination work of a paper jam (a plurality of work stages).

Note that, according to the third embodiment, both of the display output (FIG. 14) and the voice output are adopted as a method of outputting the recovery guidance information 500, but the present embodiment is not limited to this. Only one of the display output and the voice output may be adopted as a method of outputting the recovery guidance information 500.

### 4. Modification

The embodiments of the present invention have been described above, but the present invention is not limited to the above descriptions.

For example, according to each embodiment, the information for guiding the worker to the elimination stages of the abnormal event occurring in the MFP 10, is output as the work guidance information 300 (FIG. 5 to FIG. 10), but each embodiment is not limited to this. Information for guiding the worker to maintenance stages for the MFP 10 (also, referred to as maintenance-stage information) may be output as the work guidance information 300.

FIG. 15 to FIG. 18 illustrate a plurality of pieces of work guidance information 300 (311 to 314) regarding replacement work (maintenance work) of toner (toner cartridge). In a case where an MFP 10 has a remaining amount of toner less than a predetermined level, replacement work of the toner cartridge is required. A worker (e.g., a user or a serviceman) conducts the replacement work of the toner cartridge in accordance with the plurality of pieces of work guidance information 300 (311 to 314).

Similarly to the first embodiment, each piece of processing of FIG. 4 is performed in this modification.

Specifically, first, the work guidance information regarding the first work stage (first-stage guidance information) 311 is output (step S11).

FIG. 15 illustrates the first-stage guidance information 311. The first-stage guidance information 311 is information for guiding the worker to the first work stage (opening work of a front door 60) in the replacement work of the toner cartridge. Here, the front door 60 is provided with an open/closed detection sensor capable of detecting the final state of the opening work of the front door 60 (open state of the front door 60) (open/closed detection sensor for the front door 60). The opening work of the front door 60 is registered in advance as a detection target stage. Thus, completion of the opening work of the front door 60 is determined on the basis of a detected result of a state-detection sensor 8 (open/closed detection sensor for the front door 60) (steps S12 and S13). Then, when the open/closed detection sensor detects that the front door 60 is open due to the worker, the effect that the opening work of the front door 60 has been completed is determined at step S16. Output of the second-stage guidance information 312 (FIG. 16) starts (step S18).

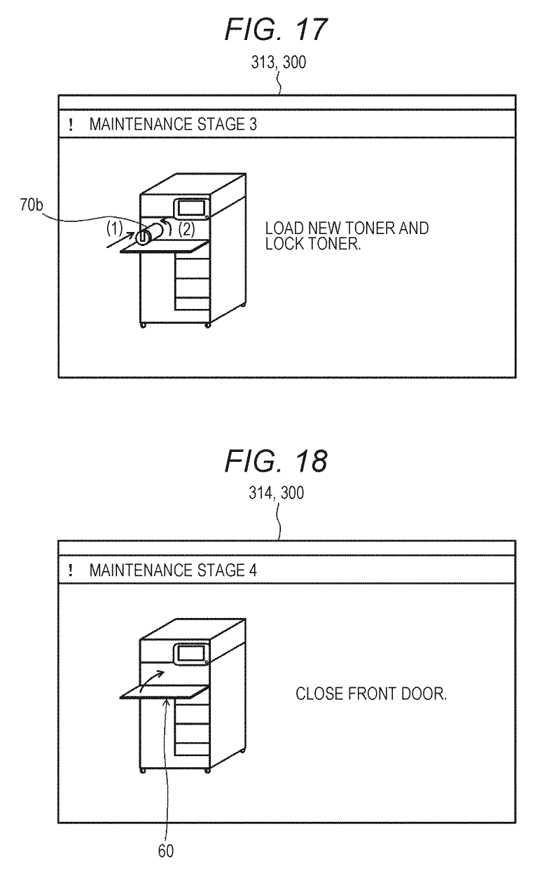

FIG. 16 illustrates the second-stage guidance information (work guidance information regarding the second work stage) 312. The second-stage guidance information 312 is information for guiding the worker to the second work stage (work of releasing the locked state of a used toner cartridge 70a (FIG. 16) and taking out the toner cartridge 70a (also, referred to as toner extraction work)) in the replacement work of the toner cartridge. Here, a toner-cartridge attachment portion (loading portion) in the body of the MFP 10, is provided with a sensor itself capable of detecting the loaded state of the toner cartridge. However, the sensor transitions to a non-conductive state along with the opening work of the front door 60. In consideration of the point, here, the toner extraction work is registered in advance as a non-detection target stage. Completion of the second work stage is determined on the basis of a voice input from the worker (steps S12, S14, and S15). Then, reception of the voice input of the effect that the toner extraction work has been conducted (“OK”), causes determination of the effect that the toner extraction work has been completed, at step S16. Output of the third-stage guidance information 313 (FIG. 17) starts (step S18).

FIG. 17 illustrates the third-stage guidance information (work guidance information regarding the third work stage) 313. The third-stage guidance information 313 is information for guiding the worker to the third work stage (work of loading a new toner cartridge 70b (FIG. 17) and locking the toner cartridge 70b (also, referred to as toner loading work)) in the replacement work of the toner cartridge. Here, similarly to the toner extraction work, the toner loading work is registered in advance as the non-detection target stage. Completion of the third work stage is determined on the basis of a voice input from the worker (steps S12, S14, and S15). Then, reception of the voice input of the effect that the toner loading work has been conducted, causes determination of the effect that the toner loading work has been completed, at step S16. Output of the fourth-stage guidance information 314 (FIG. 18) starts (step S18).

FIG. 18 illustrates the fourth-stage guidance information (work guidance information regarding the fourth (last) work stage) 314. The fourth-stage guidance information 314 is information for guiding the worker to the fourth work stage (closing work of the front door 60) in the replacement work of the toner cartridge. Here, similarly to the opening work of the front door 60, the closing work of the front door 60 is registered in advance as the detection target stage. Completion of the closing work of the front door 60 is determined on the basis of a detected result of the state-detection sensor 8 (open/closed detection sensor for the front door 60) (steps S12 and S13). Then, when the worker closes the front door 60, the effect that the closing work of the front door 60 has been completed is determined at step S16. The replacement work of the toner cartridge (maintenance work) finishes.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a hardware processor that sequentially guides a worker to a plurality of work stages according to work to be conducted by the worker at the image forming apparatus and determines completion of each of the plurality of work stages with a completion-determination method corresponding to a type of the work stage;
at least one sensor capable of detecting a final state of at least one work stage of the plurality of work stages; and
a voice inputter capable of receiving a voice input from the worker,
wherein the plurality of work stages is classified into a first type of stage and a second type of stage in advance, and
the hardware processor:
determines, in a case where a current work stage in the plurality of work stages belongs to the first type of stage, completion of the current work stage, based on a detected result of a specific sensor corresponding to the current work stage in the at least one sensor; and
determines, in a case where the current work stage belongs to the second type of stage, the completion of the current work stage, based on the voice input of an effect that the current work stage has been conducted.

2. The image forming apparatus according to claim 1,
wherein the hardware processor determines, in the case where the current work stage belongs to the first type of stage, an effect that the current work stage has been completed, on condition that the specific sensor detects an effect that a work target in the current work stage is in a final state of the current work stage.

3. The image forming apparatus according to claim 1, further comprising
an outputter that outputs a plurality of pieces of work guidance information that is information for guiding the worker to the plurality of work stages,
wherein the hardware processor causes the outputter to sequentially output the plurality of pieces of work guidance information, to sequentially guide the worker to the plurality of work stages.

4. The image forming apparatus according to claim 3,
wherein the outputter includes a display outputter, and
the hardware processor performs display output of the plurality of pieces of work guidance information with the display outputter.

5. The image forming apparatus according to claim 3,
wherein the outputter includes a voice outputter, and
the hardware processor performs voice output of the plurality of pieces of work guidance information with the voice outputter.

6. The image forming apparatus according to claim 4,
wherein the hardware processor performs, in a case where an effect that the worker is confused about the current work stage is determined, display output of detailed guidance information that is information for a more detailed guide of the current work stage, with the display outputter.

7. The image forming apparatus according to claim 5,
wherein the hardware processor performs, in a case where an effect that the worker is confused about the current work stage is determined, after the voice output of one piece of work guidance information regarding the current work stage in the plurality of pieces of work guidance information, voice output of the one piece of work guidance information again with the voice outputter.

8. The image forming apparatus according to claim 3,
wherein the hardware processor performs, in a case where an effect that different work from the current work stage has been conducted at the current work stage is determined, output of recovery guidance information that is information for recovering a state before the conduct of the different work, with the outputter.

9. The image forming apparatus according to claim 1,
wherein the plurality of work stages includes an elimination stage for an abnormal event occurring in the image forming apparatus.

10. The image forming apparatus according to claim 1,
wherein the plurality of work stages includes a maintenance stage for the image forming apparatus.

11. A non-transitory recording medium storing a computer readable program causing a computer built in an image forming apparatus to perform:
a) guiding a worker to one work stage of a plurality of work stages according to work to be conducted by the worker at the image forming apparatus;
b) determining completion of the one work stage with a completion-determination method corresponding to a type of the one work stage; and
c) performing a) the guiding and b) the determining to another work stage that is not the one work stage, in the plurality of work stages,
wherein the plurality of work stages is classified into a first type of stage and a second type of stage in advance, and
b) the determining includes:
determining, in a case where a current work stage in the plurality of work stages belongs to the first type of stage, completion of the current work stage, based on a detected result of a specific sensor corresponding to the current work stage in at least one sensor capable of detecting a final state of at least one work stage of the plurality of work stages; and
determining, in a case where the current work stage belongs to the second type of stage, the completion of the current work stage, based on a voice input of an effect that the current work stage has been conducted, from the worker.

12. The non-transitory recording medium storing a computer readable program according to claim 11,
wherein b) the determining includes determining, in the case where the current work stage belongs to the first type of stage, an effect that the current work stage has been completed, on condition that the specific sensor detects an effect that a work target in the current work stage is in a final state of the current work stage.

13. The non-transitory recording medium storing a computer readable program according to claim 11,
wherein a) the guiding includes causing an outputter of the image forming apparatus to output one piece of work guidance information regarding the current work stage in a plurality of pieces of work guidance information that is information for guiding the worker to the plurality of work stages, to guide the worker to the current work stage.

14. The non-transitory recording medium storing a computer readable program according to claim 13,
wherein the outputter includes a display outputter, and
a) the guiding includes performing display output of the one piece of work guidance information with the display outputter.

15. The non-transitory recording medium storing a computer readable program according to claim 13,
wherein the outputter includes a voice outputter, and
a) the guiding includes performing voice output of the one piece of work guidance information with the voice outputter.

16. The non-transitory recording medium storing a computer readable program according to claim 14, the program causing the computer to further perform:
d) performing, in a case where an effect that the worker is confused about the current work stage is determined, display output of detailed guidance information that is information for a more detailed guide of the current work stage, with the display outputter.

17. The non-transitory recording medium storing a computer readable program according to claim 15, the program causing the computer to further perform:
d) performing, in a case where an effect that the worker is confused about the current work stage is determined, after the voice output of the one piece of work guidance information in a) the guiding, voice output of the one piece of work guidance information again with the voice outputter.

18. The non-transitory recording medium storing a computer readable program according to claim 13, the program causing the computer to further perform:
e) performing, in a case where an effect that different work from the current work stage has been conducted at the current work stage is determined, output of recovery guidance information that is information for recovering a state before the conduct of the different work, with the outputter.

19. The non-transitory recording medium storing a computer readable program according to claim 13,
wherein the plurality of work stages includes an elimination stage for an abnormal event occurring in the image forming apparatus.

20. The non-transitory recording medium storing a computer readable program according to claim 13,
wherein the plurality of work stages includes a maintenance stage for the image forming apparatus.

21. A method of controlling an image forming apparatus, the method comprising:
a) guiding a worker to one work stage of a plurality of work stages according to work to be conducted by the worker at the image forming apparatus;
b) determining completion of the one work stage with a completion-determination method corresponding to a type of the one work stage; and
c) performing a) the guiding and b) the determining to another work stage that is not the one work stage, in the plurality of work stages,
wherein the plurality of work stages is classified into a first type of stage and a second type of stage in advance, and
b) the determining includes:
determining, in a case where a current work stage in the plurality of work stages belongs to the first type of stage, completion of the current work stage, based on a detected result of a specific sensor corresponding to the current work stage in at least one sensor capable of detecting a final state of at least one work stage of the plurality of work stages; and
determining, in a case where the current work stage belongs to the second type of stage, the completion of the current work stage, based on a voice input of an effect that the current work stage has been conducted, from the worker.
